(19) United States
(12) Patent Application Publication
(10) Pub. No.: US 2026/0088636 A1
(43) Pub. Date: Mar. 26, 2026

(54) PORTABLE ENERGY STORAGE DEVICE CAPABLE OF SIMULTANEOUS MULTI-PORT DISCHARGE AND POWER ALLOCATION METHOD

(71) Applicant: NINGBO SOYAR TECHNOLOGY INNOVATION CO., LTD., Ningbo (CN)

(72) Inventor: Tao HUANG, Ningbo (CN)

(73) Assignee: NINGBO SOYAR TECHNOLOGY INNOVATION CO., LTD., Ningbo (CN)

(21) Appl. No.: 19/329,071

(22) Filed: Sep. 15, 2025

(30) Foreign Application Priority Data
Sep. 25, 2024 (CN) 2024113440022

(51) Int. Cl. H02J 7/00; H01M 10/44; H02J 7/34

(52) U.S. Cl. CPC H02J 7/50; H01M 10/441; H02J 7/342; H02J 7/62; H02J 7/64; H02J 7/65; H02J 7/663; H02J 7/933; H02J 7/971

(57) ABSTRACT

A portable energy storage device capable of simultaneous multi-port discharge and a power allocation method. The energy storage device is equipped with multiple charging output ports, some of which have different preset power allocation priorities. This allows the user to determine the priority sequence of multiple power-receiving according to needs when using the device. The invention ensures that when multiple charging output ports are all connected to power-receiving devices and the sum of power of the power-receiving devices exceeds the maximum power that the device can provide, all ports can still operate at their respective preset minimum power. If there is remaining power, the remaining power is preferentially allocated to the charging output ports with higher priority. When the number of charging output ports connected to power-receiving devices changes, the device reallocates power, achieving dynamic power adjustment and enabling the device to operate at its maximum output power whenever possible.

### FILED OF THE INVENTION

The invention relates to the technical field of portable energy storage devices, and in particular to a portable energy storage device capable of simultaneous multi-port discharge and power allocation method.

### BACKGROUND

With the increasing popularity of mobile devices and the growing number of outdoor activities, the demand for portable energy storage devices has been rising steadily. Whether for outdoor camping, emergency power needs, or daily charging of mobile devices, portable energy storage devices capable of providing reliable power have become indispensable tools.

In the prior art, portable energy storage devices have evolved to feature multiple charging output ports, each of which can be connected to an electronic device for charging. However, in such devices, the output power of each charging output port is either fixed for example, in a device with three charging output ports, each port may be limited to an output power of 50 W. In this case, even when only one charging output port is in use, it can still operate only at 50 W, resulting in the inability to achieve maximum single-port output. Alternatively, some devices support maximum power output for a given charging output port through complex power distribution logic, but this approach is complicated to operate and provides a poor user experience.

For example, Chinese Patent CN112671055B, in its earlier application, seeks protection for a power distribution method and a charging device, wherein power is allocated to each output port according to the connection sequence of the devices and the power demand of each connected device. Paragraphs [0080] to [0085] of its specification describe in detail the specific process of allocating power to the first, second, and third output ports according to the order in which the devices are connected. In brief: assuming that the total power available from the charging device is 100 W, when a first device occupies 60 W of power via the first output port, the remaining power of the charging device is 40 W. When a second device is connected to the second output port, and its maximum charging power is 100 W, since this exceeds the remaining 40 W, the second device charges at 40 W. When a third device is connected to the third output port, assuming that its maximum charging power is 150 W and its minimum charging power is 15 W, since the total power of 100 W has already been fully allocated to the first and second output ports, the system first satisfies the third device's minimum charging power of 15 W and correspondingly reduces the power supplied to the first and second devices.

It is thus apparent that Chinese Patent CN112671055B determines the priority of power allocation based on the sequence in which electronic devices are connected to the charging device—namely, the earlier a device is connected, the higher its priority for having its power demand satisfied. This means that if a user wishes to give priority to a later-connected device, they would need to disconnect all devices currently being charged in order to reorder the priority. Such an operation is detrimental to both the charging device and the electronic devices, and also results in a poor user experience.

### SUMMARY OF THE INVENTION

To address the shortcomings of the prior art, the objective of the present invention is to provide a portable energy storage device capable of simultaneous multi-port discharge, as well as a power allocation method applicable to such a portable energy storage device. By predefining the priorities of multiple charging output ports, the invention enables the user, during operation, to select a charging output port of a particular priority according to actual needs, thereby allowing for the advance and reasonable arrangement of the connection relationship between the electronic devices to be charged and the charging output ports.

To achieve the above-mentioned objective, the present invention provides the following technical solution:

According to the first aspect of the present invention, a portable energy storage device capable of simultaneous multi-port discharge is provided, comprising a power configuration unit and at least three charging output ports, wherein the power configuration unit is configured to allocate power to the charging output ports connected to power-receiving devices, each charging output port being preset with a power distribution priority, a minimum output power, and a maximum output power; defining the maximum total output power of the energy storage device as Pmax_out, and the number of charging output ports connected to power-receiving devices as Y, defining these ports as the first to the Y-th charging output ports sequentially, their minimum output powers as Pmin_c1 to Pmin_cY, and the smaller of their maximum output power and load request power as the first to the Y-th preset powers;
when Y≥3 and the Y ports include at least two priorities and one of the priority includes at least two ports, define the ports of the same priority as a group; then when (Pmin_c1+ . . . +Pmin_cY)<Pmax_out<(first preset power+ . . . +Y-th preset power), the power configuration unit first satisfies the minimum output power of said ports, allocating the remaining power in sequence according to the priority order until the remaining power becomes zero and following the rules below:
first, the charging output port groups are ranked from high to low priority; when all ports in a higher-priority group have reached their preset power and there is still remaining power, the power configuration unit continues to allocate the remaining power to the next group of charging output ports; second, for each port within a group, the difference between the current power of each port and its preset power is defined as the required supplementary power of that port, then:
if the current remaining power≥the sum of required supplementary power of all ports not yet reaching their preset power, the power configuration unit allocates the remaining power making all such ports reach their preset power; if the current remaining power<the sum of required supplementary power of all ports not yet reaching their preset power, the power configuration unit continuously allocates the remaining power within the group according to the following rules until the remaining power becomes zero:
if (current remaining power/number of ports not yet reaching preset power)≤the required supplementary power of each port not yet reaching preset power, the remaining power is evenly distributed among all ports not yet reaching preset power by the power configuration unit;
if (current remaining power/number of ports not yet reaching preset power)≤the required supplementary power of some ports not yet reaching preset power, the power configuration unit allocates the remaining power to the ports not yet reaching preset power within the group by taking the minimum required supplementary power among such ports as the distribution power;
if Pmax_out=(Pmin_c1+ . . . +Pmin_cY), the power configuration unit allocates to each charging output port connected to a power-receiving device its corresponding minimum output power;
if Pmax_out≥(first preset power+ . . . +Y-th preset power), the power configuration unit allocates to each charging output port connected to a power-receiving device its corresponding preset power.

Furthermore, the priority includes at least two ports is not lowest priority.

Furthermore, in the case of (Pmin_c1+ . . . +Pmin_cY)<Pmax_out<(first preset power+ . . . +Y-th preset power), when Y≥2 and the Y charging output ports have different priorities, the power configuration unit first ensures the minimum output power of said ports, and then allocates the remaining power sequentially according to the priority order until the remaining power becomes zero, following the rules below:
first, the charging output ports are ranked from high to low priority; when a higher-priority port reaches its preset power and there is still remaining power, the power configuration unit continues to allocate the remaining power to the next charging output port;
second, for each charging output port, the difference between its current power and its preset power is defined as the required supplementary power of that port, then:
if the current remaining power≥the required supplementary power of that port, the power configuration unit allocates the remaining power making the port reaches its preset power;
if the current remaining power<the required supplementary power of that port, the power configuration unit allocates all remaining power to that port.

Furthermore, in the case of (Pmin_c1+ . . . +Pmin_cY)<Pmax_out<(first preset power+ . . . +Y-th preset power), when Y≥2 and the Y charging output ports have the same priority, the power configuration unit first ensures the minimum output power of said ports, and then continuously allocates the remaining power until it becomes zero, following the rules below, in which the difference between the current power of each port and its preset power is defined as its required supplementary power:
if (current remaining power/number of charging output ports not yet reaching preset power)≤the required supplementary power of each charging output port not yet reaching preset power, the power configuration unit evenly distributes the remaining power among all charging output ports not yet reaching preset power;
if (current remaining power/number of charging output ports not yet reaching preset power)≤the required supplementary power of some charging output ports not yet reaching preset power, and (current remaining power/number of charging output ports not yet reaching preset power)>the required supplementary power of the other charging output ports not yet reaching preset power, the power configuration unit allocates the remaining power to the charging output ports not yet reaching preset power within the group by taking the minimum required supplementary power among such ports as the distribution power.

Furthermore, when only one charging output port is connected to a power-receiving device, the power configuration unit allocates to the charging output port a power equal to the smaller of its maximum output power and the requested load power as the allocated power.

Furthermore, the portable energy storage device comprises a main control board and one or more independent circuit boards connected to the main control board, the charging output ports provided on the circuit boards, and the power configuration unit being disposed on the main control board.

Furthermore, the power configuration unit reads preset parameters of the charging output ports, calculates the real-time power demand of each charging output port, and allocates discharge power accordingly, the preset parameters including current and voltage.

Furthermore, protection circuits are provided on both the circuit boards and the main control board, the protection circuits comprising one or more of: an over-current protection circuit, an over-voltage protection circuit, an over-temperature protection circuit, and a short-circuit protection circuit, and when an abnormal condition is detected, the protection circuit responds and interrupts the power supply of the relevant circuit.

According to the second aspect of the present invention, a power allocation method for a portable energy storage device is provided, applied to the portable energy storage device according to the first aspect of the present invention, the method comprising: when Y≥3 and the Y ports include at least two priorities and one of the priority includes at least two ports, define the ports of the same priority as a group; then when (Pmin_c1+ . . . +Pmin_cY)<Pmax_out<(first preset power+ . . . +Y-th preset power), the power configuration unit first satisfies the minimum output power of said ports, allocating the remaining power in sequence according to the priority order until the remaining power becomes zero and following the rules below:
first, the charging output port groups are ranked from high to low priority; when all ports in a higher-priority group have reached their preset power and there is still remaining power, the power configuration unit continues to allocate the remaining power to the next group of charging output ports; second, for each port within a group, the difference between the current power of each port and its preset power is defined as the required supplementary power of that port, then:
if the current remaining power≥the sum of required supplementary power of all ports not yet reaching their preset power, the power configuration unit allocates the remaining power making all such ports reach their preset power; if the current remaining power<the sum of required supplementary power of all ports not yet reaching their preset power, the power configuration unit continuously allocates the remaining power within the group according to the following rules until the remaining power becomes zero:
if (current remaining power/number of ports not yet reaching preset power)≤the required supplementary power of each port not yet reaching preset power, the remaining power is evenly distributed among all ports not yet reaching preset power by the power configuration unit;
if (current remaining power/number of ports not yet reaching preset power)≤the required supplementary power of some ports not yet reaching preset power, the power configuration unit allocates the remaining power to the ports not yet reaching preset power within the group by taking the minimum required supplementary power among such ports as the distribution power.

Furthermore, in the case of (Pmin_c1+ . . . +Pmin_cY)<Pmax_out<(first preset power+ . . . +Y-th preset power), when Y≥2 and the Y charging output ports have different priorities, the power configuration unit first ensures the minimum output power of said ports, and then allocates the remaining power sequentially according to the priority order until the remaining power becomes zero, following the rules below:
first, the charging output ports are ranked from high to low priority; when a higher-priority port reaches its preset power and there is still remaining power, the power configuration unit continues to allocate the remaining power to the next charging output port;
second, for each charging output port, the difference between its current power and its preset power is defined as the required supplementary power of that port, then:
if the current remaining power≥the required supplementary power of that port, the power configuration unit allocates the remaining power making the port reaches its preset power;
if the current remaining power<the required supplementary power of that port, the power configuration unit allocates all remaining power to that port.

Furthermore, in the case of (Pmin_c1+ . . . +Pmin_cY)<Pmax_out<(first preset power+ . . . +Y-th preset power), when Y≥2 and the Y charging output ports have the same priority, the power configuration unit first ensures the minimum output power of said ports, and then continuously allocates the remaining power until it becomes zero, following the rules below, in which the difference between the current power of each port and its preset power is defined as its required supplementary power:
if (current remaining power/number of charging output ports not yet reaching preset power)≤the required supplementary power of each charging output port not yet reaching preset power, the power configuration unit evenly distributes the remaining power among all charging output ports not yet reaching preset power;
if (current remaining power/number of charging output ports not yet reaching preset power)≤the required supplementary power of some charging output ports not yet reaching preset power, and (current remaining power/number of charging output ports not yet reaching preset power)>the required supplementary power of the other charging output ports not yet reaching preset power, the power configuration unit allocates the remaining power to the charging output ports not yet reaching preset power within the group by taking the minimum required supplementary power among such ports as the distribution power.

Compared with the prior art, the present invention provides the following advantages:
1. The portable energy storage device and the power allocation method of the present invention ensure that when multiple charging output ports are connected to power-receiving devices and the total required power exceeds the maximum power the device can provide, all ports can still operate at their preset minimum power.
2.According to the portable energy storage device and power allocation method provided by the present invention, after multiple charging output ports are connected to power-receiving devices and power is allocated according to preset rules, if a power-receiving device is removed from a charging output port during operation, thereby changing the number of connected ports, power is reallocated according to the preset rules based on the current number of connected ports. In this way, the power released from the removed device can be redistributed to the remaining connected ports, enabling the portable energy storage device to output power as close as possible to its maximum capacity and achieve dynamic adjustment.
3.According to the portable energy storage device and power allocation method provided by the present invention, some of the charging output ports can have different preset priorities. As a result, users can set the priority order of multiple power-receiving devices according to actual needs, making the device convenient and easy to operate.
4.According to the portable energy storage device and power allocation method provided by the present invention, some of the charging output ports can have same preset priorities. On the basis of the predefined power allocation logic, when distributing power to charging output ports of equal priority, the power configuration unit takes into account the required power of these ports and allocates the available power as evenly as possible.

### BRIEF DESCRIPTION OF THE DRAWINGS

Other features, objectives, and advantages of the present invention will become apparent from the following detailed description of non-limiting embodiments in conjunction with the accompanying drawings:

FIG. 1 is a schematic diagram of the structure of a portable energy storage device according to the first embodiment of the present invention, in which the number of charging output ports connected to a power-receiving device is eight;

FIG. 2 is a schematic diagram of the structure of a portable energy storage device according to the second embodiment of the present invention, in which the number of charging output ports connected to a power-receiving device is three;

FIG. 3 is a schematic diagram of the structure of the portable energy storage device according to the second embodiment of the present invention, in which the number of charging output ports connected to a power-receiving device is four.

### EMBODIMENT

To clarify the purpose, technical solution, and advantages of the embodiments described herein, the following detailed description of the embodiments provided in the accompanying drawings is presented. It is understood that the described embodiments are part of this application, and not all possible embodiments are depicted. Components shown and described in the drawings can be arranged and designed in various configurations.

Therefore, the detailed description of the embodiments provided in the drawings is not intended to limit the scope of the claims of this application, but only to represent selected embodiments thereof. All other embodiments obtained by those skilled in the art without creative labor based on the embodiments disclosed herein are within the scope of protection of this application.

It should be noted that similar numerals and letters in the following drawings represent similar elements. Therefore, once an element is defined in one drawing, it does not need to be further defined or explained in subsequent drawings. Additionally, all directional indications (such as up, down, left, right, front, rear, bottom, etc.) used in this application are for explaining the relative positional relationships and movements of the components in a specific orientation (as shown in the drawings). If this specific orientation changes, the directional indications also change Accordingly. Furthermore, descriptions involving “first,” “second,” etc., are used for descriptive purposes only and should not be construed to indicate or imply relative importance or the quantity of the indicated technical features.

### Embodiment 1

In this embodiment, a portable energy storage device capable of simultaneous multi-port discharge is provided. Structurally, the energy storage device is made of a lightweight and high-strength housing material. Inside, one or more independent circuit boards are provided, each equipped with power input and charging output ports, and connected to a main control board via wiring. The main control board is embedded with an intelligent control chip that includes a power configuration unit configured to execute a power distribution algorithm. The power configuration unit calculates the real-time power demand of each port by reading parameters such as current and voltage from each port, and accordingly adjusts the charging and discharging power of each port. In addition, both the circuit boards and the main control board are provided with overcurrent protection, overvoltage protection, overtemperature protection, and short-circuit protection components. When an abnormal condition is detected, these protection circuits respond quickly and cut off the power supply to the relevant circuit.

Since the core of this embodiment lies in the power distribution logic of the energy storage device when operating in discharge-only mode, the specific details are described as follows: The portable energy storage device provided in this embodiment, capable of discharging through multiple ports simultaneously, comprises at least three charging output ports and a power configuration unit. The power configuration unit is configured to allocate power to the charging output ports connected to power-receiving devices; that is, if a charging output port is not connected to a power-receiving device, no power is allocated to that port. As used herein, a ‘power-receiving device’ refers to a device being charged, such as a mobile phone, a camera, or the like.

Each charging output port is preset with a power allocation priority, with some ports sharing the same priority. When charging output ports of different priorities are connected to power-receiving devices, the power configuration unit allocates power preferentially to meet the requirements of higher-priority ports. When charging output ports of the same priority are connected to power-receiving devices, the power configuration unit considers their power requirements simultaneously and distributes power as evenly as possible. Each charging output port is preset with a minimum output power and a maximum output power. ‘Minimum output power’ refers to the minimum power the power configuration unit will allocate to the port, while ‘maximum output power’ refers to the maximum power the power configuration unit will allocate to the port.

The maximum total output power of the portable energy storage device provided in this embodiment is defined as Pmax_out (in the present application, the sum of the preconfigured minimum output powers of the charging output ports is less than or equal to Pmax_out; the minimum output power of each charging output port is less than or equal to its maximum output power; and the maximum output power of each charging output port is less than or equal to Pmax_out).

The number of charging output ports connected to power-receiving devices is defined as Y (it should be understood that Y is less than or equal to the total number of charging output ports of the portable energy storage device). These Y charging output ports connected to power-receiving devices are sorted by priority from high to low (for charging output ports with the same priority, the order is arbitrary), and are sequentially defined them as the first charging output port through the Y-th charging output port. Their minimum output powers are sequentially defined as Pmin_c1 to Pmin_cY, and the smaller of each port's maximum output power and load request power is sequentially defined as the first preset power through the Y-th preset power. The term “load request power” refers to the power required by the power-receiving device, as a load, under normal operating conditions, which may vary depending on the specific device connected.

This embodiment discusses the case where Y≥3 and among these Y charging output ports, there are at least two priorities and one of the priority includes at least two charging output ports (the priority with at least two charging output ports can be the lowest priority or a non-lowest priority). Charging output ports with the same priority are defined as a charging output port group (if a priority corresponds to only one charging output port, that port forms a group by itself). Then:
1. if Pmax_out=(Pmin_c1+ . . . +Pmin_cY), that is, the maximum total output power of the portable energy storage device equals the sum of the minimum output powers of the charging output ports connected to power-receiving devices, the power configuration unit allocates to each connected charging output port its corresponding minimum output power;
2. if Pmax_out≥(first preset power+ . . . +Y-th preset power), that is, the maximum total output power of the portable energy storage device is greater than or equal to the sum of the preset powers of the charging output ports connected to power-receiving devices, the power configuration unit allocates to each connected charging output port its corresponding preset power;
3. if (Pmin_c1+ . . . +Pmin_cY)<Pmax_out<(first preset power+ . . . +Y-th preset power), the power configuration unit first satisfies the minimum output power of these charging output ports (i.e., it first allocates to each charging output port connected to a power-receiving device its corresponding minimum output power), and then sequentially allocates the remaining power according to priority until the remaining power becomes zero and follow the rules below:
(1) the charging output port groups are ranked from high to low priority; only when all ports in a higher-priority group have reached their preset power and there is still remaining power, the power configuration unit continues to allocate the remaining power to the next group of charging output ports;
(2) for each charging output port within a group, the difference between the current power of each port and its preset power is defined as the required supplementary power of that port, then:
\textcircled{1} if the current remaining power≥the sum of required supplementary power of all charging output ports not yet reaching their preset power, the power configuration unit allocates the remaining power making all such ports reach their preset power;
\textcircled{2} if the current remaining power<the sum of required supplementary power of all charging output ports not yet reaching their preset power, the power configuration unit continuously allocates the remaining power within the group according to the following rules until the remaining power becomes zero:
a. if (current remaining power/number of charging output ports not yet reaching preset power)≤the required supplementary power of each charging output port not yet reaching preset power, the power configuration unit evenly distributes the remaining power among all charging output ports not yet reaching preset power;
b. if (current remaining power/number of charging output ports not yet reaching preset power)≤the required supplementary power of some charging output ports not yet reaching preset power, and (current remaining power/number of charging output ports not yet reaching preset power)>the required supplementary power of other charging output ports not yet reaching preset power, the power configuration unit allocates the remaining power to the charging output ports not yet reaching preset power within the group by taking the required supplementary power of a charging output port with the minimum required supplementary power among such ports as the distribution power.

To further illustrate the above technical solution, the following provides a detailed explanation of the remaining power allocation logic through successive rounds of distributing the remaining power.

Assume that a charging output port group contains NO ports and the remaining power to be allocated is P₀. Then:
1. if the sum of the required supplemental power of all charging output ports in the group≤P₀, the power configuration unit allocates each charging output port its required supplemental power making all charging output ports in the group reach preset power. If there is still remaining power left and since all charging output ports in the group have reached preset power, the remaining power can be further allocated to the charging output ports of the next group;
2. if the sum of the required supplemental power of all charging output ports in the group >P₀, meaning the remaining power P₀ is insufficient to bring every port in the group to its preset power, the following two cases are considered:
(1) if the required supplemental power of each charging output port>(P₀/N₀), the power configuration unit evenly distributes P₀ among all ports in the group. In this case, as the remaining power is exhausted, the allocation of remaining power ends;
(2) if the required supplementary power of some charging output ports<(P₀/N₀), and the required supplementary power of other charging output ports≥(P₀/N₀), the power configuration unit performs a first round of remaining power allocation. In this round, the power configuration unit allocates the remaining power to the charging output ports within the group by taking the required supplementary power of a charging output port with the minimum required supplementary power among such ports as the distribution power.

At this point, the charging output port with the smallest required supplemental power has reached its preset power, while the remaining ports have not yet reached preset power. Therefore, remaining power is again allocated within the group. Assume that after the first round of remaining power allocation, the remaining power is P₁, and the number of charging output ports in the group that have not yet reached their preset power is N₁. Then:
\textcircled{1} if the required supplemental power of all N₁ charging output ports not yet reached their preset power≥(P₁/N₁), the power configuration unit evenly distributes P₁ among these N₁ charging output ports not yet reached their preset power. In this case, as the remaining power is exhausted, the allocation of remaining power ends;
\textcircled{2} if among these N₁ ports, the required supplemental power of some ports not yet reached preset power<(P₁/N₁), and the required supplemental power of other ports not yet reached preset power≥(P₁/N₁), the power configuration unit performs a second round of remaining power allocation. In this round, the power configuration unit allocates the remaining power to the charging output ports not yet reached preset power within the group by taking the required supplementary power of a charging output port with the minimum required supplementary power among the N₁ charging output ports not yet reached preset power as the distribution power.

At this point, among the N₁ charging output ports that have not yet reached preset power, the charging output port with the smallest required supplemental power has reached its preset power, while the remaining ports have not yet reached preset power. Therefore, remaining power is again allocated within the group. Assume that after the second round of remaining power allocation, the remaining power is P₂, and the number of charging output ports in the group that have not yet reached their preset power is N₂. Then:
a. if the required supplemental power of all N₂ charging output ports not yet reached their preset power≥(P₂/N₂), the power configuration unit evenly distributes P₂ among these N₂ charging output ports not yet reached their preset power. In this case, as the remaining power is exhausted, the allocation of remaining power ends;
b. if among these N₂ ports, the required supplemental power of some ports not yet reached preset power<(P₂/N₂), and the required supplemental power of other ports not yet reached preset power≥(P₂/N₂), the power configuration unit performs a third round of remaining power allocation. In this round, the power configuration unit allocates the remaining power to the charging output ports not yet reached preset power within the group by taking the required supplementary power of a charging output port with the minimum required supplementary power among the N₂ charging output ports not yet reached preset power as the distribution power.

At this point, among the N₂ charging output ports that have not yet reached preset power, the charging output port with the smallest required supplemental power has reached its preset power, while the remaining ports have not yet reached preset power. Therefore, remaining power is again allocated within the group. Assume that after the third round of remaining power allocation, the remaining power is P₃, and the number of charging output ports in the group that have not yet reached their preset power is N₃.

By analogy with the aforementioned rules (1) and (2), or rules \textcircled{1} and \textcircled{2}, or rules a and b, the process continues until the remaining power becomes zero.

From the above examples, it can be understood that the so-called “current” remaining power, “current” charging output ports not yet reached preset power, and the “current” power of each charging output port all refer to the current state when the remaining power is about to be allocated. For example, when the first round of remaining power distribution is about to be allocated, the current remaining power is P₀, and the “current” power of each charging output port is minimum output power; when the second round of remaining power distribution is about to be allocated, the current remaining power is P₁, where P₁=(P₀−the remaining power allocated in the first round), and the “current” power of each charging output port is its (minimum output power+the remaining power allocated to it in the first round of remaining power distribution), and so on. In addition, changes in the current power of each charging output port led to changes in its required supplemental power, since, as described above, the required supplemental power of each charging output port=preset power−current power.

The following provides specific numerical examples to further illustrate the technical solution of this embodiment:

In a certain portable energy storage device, as shown in FIG. 1, it has 8 charging output ports connected to power receiving devices. As shown in Table 1 below, sorted by priority from high to low, these charging output ports are named as Port 1-1, Port 1-2; Port 2-1, Port 2-2, Port 2-3, Port 2-4, Port 2-5; Port 3-1. Among them, Port 1-1 and Port 1-2 have the same priority, and the two form the first group of charging output ports; Port 2-1, Port 2-2, Port 2-3, Port 2-4, and Port 2-5 have the same priority, and these five ports form the second group of charging output ports; Port 3-1 forms the third group of charging output ports. It is assumed that the relevant data of these ports are as shown in Table 1 below:

TABLE 1

| | | | | | | | | The Third |
|---|---|---|---|---|---|---|---|---|
| | The First Group | | The Second Group | | | | | Group |
| Relevant | Port | | | | | | | |
| Parameters | Port 1-1 | Port 1-2 | Port 2-1 | Port 2-2 | Port 2-3 | Port 2-4 | Port 2-5 | Port 3-1 |
| Pmin | 20 W | 10 W | 30 W | 40 W | 35 W | 50 W | 45 W | 60 W |
| Preset Power | 30 W | 20 W | 40 W | 60 W | 70 W | 60 W | 60 W | 100 W |

(1) if the maximum total output power Pmax_out of the portable energy storage device is 290 W, then because Pmax_out=(Pmin_c1-1+Pmin_c1-2+Pmin_c2-1+Pmin_c2-2+Pmin_c2-3+Pmin_c2-4+Pmin_c2-5+Pmin_c3-1)=(20 W+10 W+30 W+40 W+35 W+50 W+45 W+60 W)=290 W=Pmax_out, that is, the maximum total output power of the portable energy storage device equals the sum of the minimum output powers of the charging output ports connected to power-receiving devices, the power configuration unit allocates to each charging output port connected to a power-receiving device its corresponding minimum output power;
(2) if the maximum total output power Pmax_out of the portable energy storage device is 450 W, then because Preset Power of 1-1+Preset Power of 1-2+Preset Power of 2-1+Preset Power of 2-2+Preset Power of 2-3+Preset Power of 2-4+Preset Power of 2-5+Preset Power of 3−1=440 W<Pmax_out, that is, the maximum total output power of the portable energy storage device>the sum of the preset powers of the charging output ports connected to power-receiving devices, the power configuration unit allocates to each charging output port connected to a power-receiving device its corresponding preset power;
(3) if the maximum total output power Pmax_out of the portable energy storage device is 350 W, since (Pmin_c1-1+Pmin_c1-2+ . . . +Pmin_c3-1)≤Pmax_out<(Preset Power of 1-1+Preset Power of 1-2+ . . . +Preset Power of 3-1), the power configuration unit first satisfies the minimum output power of these charging output ports (that is, first allocates to each charging output port connected to a power-receiving device its corresponding minimum output power), and then the power configuration unit sequentially allocates the remaining power according to the priority order until the remaining power becomes zero. The current remaining power is defined as P₀, P₀=350 W−(Pmin_c1-1+Pmin_c1-2+ . . . +Pmin_c3-1)=350 W−290 W=60 W.

The remaining power, in the order from high to low priority, is first allocated to the first group of charging output ports. When allocating the remaining power to the first group of charging output ports, for Port 1-1, its required supplementary power is the difference between its current power (i.e., Pmin_c1-1) and its preset power, that is, 30 W−20 W=10 W; for Port 1-2, its required supplementary power is the difference between its current power (i.e., Pmin_c1-2) and its preset power, that is, 20 W−10 W=10 W. Since the current remaining power P₀>the sum of the required supplementary power of the charging output ports in the first group not yet reached the preset power, i.e., Port 1-1 and Port 1-2, the power configuration unit performs allocation of the remaining power so that Port 1-1 and Port 1-2 both reach the preset power. Port 1-1 reaching the preset power 30 W, means that Port 1-1 is allocated 10 W of remaining power; Port 1-2 reaching the preset power 20 W, means that Port 1-2 is allocated 10 W of remaining power.

After the allocation of the remaining power to the first group of charging output ports, the first group of charging output ports all reach the preset power and the remaining power still has surplus, therefore the power configuration unit further allocates the remaining power to the second group of charging output ports. When allocating the remaining power to the second group of charging output ports, the current remaining power is defined as P₁, P₁=P₀−the remaining power allocated to the first group of charging output ports=60 W−20 W=40 W.

When allocating the remaining power to the second group of charging output ports, for Port 2-1, its required supplementary power is the difference between the current power (i.e., Pmin_c2-1) and its preset power, namely 40 W−30 W=10 W; for Port 2-2, its required supplementary power is the difference between the current power (i.e., Pmin_c2-2) and its preset power, namely 60 W−40 W=20 W; for Port 2-3, its required supplementary power is the difference between the current power (i.e., Pmin_c2-3) and its preset power, namely 70 W−35 W=35 W; for Port 2-4, its required supplementary power is the difference between the current power (i.e., Pmin_c2-4) and its preset power, namely 60 W−50 W=10 W; for Port 2-5, its required supplementary power is the difference between the current power (i.e., Pmin_c2-5) and its preset power, namely 60 W−45 W=15 W.

It is calculated that (P₁/number of charging output ports in the second group)=40 W/5=8 W. Since, among the charging output ports in the second group, the required supplementary power of each charging output port is greater than (P₁/number of charging output ports in the second group), the power allocation unit will allocate all of the current remaining power equally to the charging output ports in the second group, that is, each charging output port is allocated 8 W of remaining power. The charging output ports in the second group have not reached the preset power, and at this time the remaining power also has no surplus, therefore, the allocation of the remaining power ends. Meanwhile, the charging output ports in the third group are not allocated remaining power.
(4) If the maximum total output power Pmax_out of the portable energy storage device is 390 W, since (Pmin_c1-1+Pmin_c1-2+ . . . +Pmin_c3-1)≤Pmax_out<(preset power of Port 1-1+preset power of Port 1-2+ . . . +preset power of Port 3-1), the power allocation unit first satisfies the minimum output power of these charging output ports, and then the power allocation unit sequentially allocates the remaining power in order of priority until the remaining power becomes zero. The current remaining power is defined as P₀, P₀=390 W−290 W=100 W.

Since the remaining power P₀>the sum of the required supplementary power of Port 1-1 and Port 1-2 within the first group of charging output ports, the power allocation unit carries out the allocation of the remaining power so that both Port 1-1 and Port 1-2 reach their preset power. After the power allocation unit completes the allocation of the remaining power for the first group of charging output ports, since the first group of charging output ports all reach their preset power and there is still remaining power left, the power allocation unit further allocates the remaining power to the second group of charging output ports. When allocating the remaining power to the second group of charging output ports, the current remaining power is defined as P₁, P₁=P₀−the remaining power allocated to the first group of charging output ports=100 W−20 W=80 W. For Port 2-1, its required supplementary power is 10 W; for Port 2-2, its required supplementary power is 20 W; for Port 2-3, its required supplementary power is 35 W; for Port 2-4, its required supplementary power is 10 W; for Port 2-5, its required supplementary power is 15 W.

It is calculated that (P₁/number of charging output ports in the second group)=80 W/5=16 W. Since, among the second group of charging output ports, the required supplementary power of some charging output ports (Port 2-1, Port 2-4, Port 2-5)<(P₁/number of charging output ports in the second group), while the required supplementary power of other charging output ports (port 2-2, port 2-3)>(P₁/number of charging output ports in the second group), the power allocation unit first takes the required supplementary power 10 W of the ports with the smallest required supplementary power in the second group, namely Port 2-1 and Port 2-4, as the allocation power and allocates it to each charging output port in the second group. As a result, Port 2-1 and Port 2-4 each obtain 10 W of remaining power and thereby reach their preset power; meanwhile, Port 2-2 obtains 10 W of remaining power, making its current power 50 W, and its required supplementary power is the difference between its preset power and current power, namely 10 W; Port 2-3 obtains 10 W of remaining power, making its current power 45 W, and its required supplementary power is the difference between its preset power and current power, namely 25 W; Port 2-5 obtains 10 W of remaining power, making its current power 55 W, and its required supplementary power is the difference between its preset power and current power, namely 5 W.

Define the current remaining power as P₂, P₂=P₁−the remaining power already allocated to the second group of charging output ports=80 W−50 W=30 W. At this time, although P₂>0, the ports within the second group of charging output ports have not all yet reached their preset power, therefore it is necessary to again perform remaining power allocation for the second group of charging output ports.

As previously described, at this time, Port 2-1 and Port 2-4 have both reached their preset power. Among the second group of charging output ports, the charging output ports that have not yet reached their preset power are Port 2-2, Port 2-3, and Port 2-5, with a quantity of 3. It is calculated that (current remaining power/number of ports not yet reaching preset power)=P₂/3=30 W/3=10 W. At this time, the required supplementary power of Port 2-2, Port 2-3, and Port 2-5 is respectively 10 W, 25 W, and 5 W. Since the required supplementary power of some charging output ports (Port 2-5 only, actually)≤(P₂/3) and the required supplementary power of other charging output ports (Port 2-2, Port 2-3)>(P₂/3), therefore, the power allocation unit first takes the required supplementary power 5 W of the port with the smallest required supplementary power among these three ports, namely Port 2-5, as the allocation power and allocates it to these three charging output ports. As a result, Port 2-2, Port 2-3, and Port 2-5 are each allocated 5 W of remaining power. At this time, Port 2-5 reaches its preset power, while Port 2-2 and Port 2-3 have not yet reached their preset power. The current power of Port 2-2 reaches 55 W, and its required supplementary power is the difference between its preset power and its current power, namely 5 W; the current power of Port 2-3 is 50 W, and its required supplementary power is the difference between its preset power and its current power, namely 20 W.

Define the current remaining power as P₃, P₃=P₁−the remaining power already allocated to the second group of charging output ports=80 W−50 W=30 W. At this time, although P₃>0, the ports within the second group of charging output ports have not all yet reached their preset power, therefore it is necessary to again perform remaining power allocation for the second group of charging output ports.

At this time, Port 2-1, Port 2-4, and Port 2-5 have all reached their preset power. Among the second group of charging output ports, the charging output ports that have not yet reached their preset power are Port 2-2 and Port 2-3, with a quantity of 2. It is calculated that (current remaining power/number of ports not yet reaching preset power)=P₃/2=15 W/2=7.5 W, and the required supplementary power of Port 2-2 and Port 2-3 is 5 W and 20 W, respectively. Since the required supplementary power of some charging output ports (Port 2-2 only, actually)<(P₃/2) and the required supplementary power of other charging output ports>(P₃/2), the power allocation unit first takes the required supplementary power 5 W of the port with the smallest required supplementary power among these two ports, namely Port 2-2, as the allocation power and allocates it to these two charging output ports. As a result, Port 2-2 and Port 2-3 are each allocated 5 W of remaining power. At this time, Port 2-2 reaches its preset power, while Port 2-3 has not yet reached its preset power, and the current power of Port 2-3 reaches 55 W. Its required supplementary power is the difference between its preset power and its current power, namely 15 W.

Define the current remaining power as P₄, P₄=P₁−the remaining power already allocated to the second group of charging output ports=80 W−50 W=30 W. At this time, although P₄>0, the ports within the second group of charging output ports have not all yet reached their preset power, therefore it is necessary to again perform remaining power allocation for the second group of charging output ports.

At this time, Port 2-1, Port 2-2, Port 2-4, and Port 2-5 have all reached their preset power. Among the second group of charging output ports, the charging output port that has not yet reached its preset power is only Port 2-3, with a quantity of 1. It is calculated that (current remaining power/number of ports not yet reaching preset power)=P₄/1=5 W, while the required supplementary power of Port 2-3 is 15 W. Since (current remaining power P₄/number of ports not yet reaching preset power) is less than the required supplementary power of Port 2-3, the power allocation unit allocates all of the current remaining power 5 W to Port 2-3.

After the above remaining power allocation, since the current remaining power is already zero, the remaining power allocation ends, and the third group of charging output ports does not receive any remaining power.
(5) If the maximum total output power Pmax_out of the portable energy storage device is 430 W, since (Pmin_c1-1+Pmin_c1-2+ . . . +Pmin_c3-1)<Pmax_out<(preset power of Port 1-1+preset power of Port 1-2+ . . . +preset power of Port 3-1), the power allocation unit first satisfies the minimum output power of these charging output ports (that is, first allocates to each charging output port connected to a power-receiving device its corresponding minimum output power), and then the power allocation unit sequentially allocates the remaining power in order of priority until the remaining power becomes zero. The current remaining power is defined as P₀, P₀=430 W−(Pmin_C1-1+Pmin_C1-2+ . . . +Pmin_C3-1)=430 W−290 W=140 W.

Since the current remaining power P₀>the sum of the required supplementary power of Port 1-1 and Port 1-2 within the first group of charging output ports, the power allocation unit carries out the allocation of the remaining power so that both Port 1-1 and Port 1-2 reach their preset power. After the power allocation unit completes the allocation of the remaining power for the first group of charging output ports, since the first group of charging output ports all reach their preset power and there is still remaining power left, the power allocation unit further allocates the remaining power to the second group of charging output ports. When allocating the remaining power to the second group of charging output ports, the current remaining power is defined as P₁, P₁=P₀−remaining power allocated to the first group of charging output ports=140 W−20 W=120 W.

Since the current remaining power P₁>the sum of the required supplementary power of the ports in the second group of charging output ports, the power allocation unit allocates the remaining power so that Port 2-1, Port 2-2, Port 2-3, Port 2-4, and Port 2-5 all reach their preset power. After the power allocation unit completes the remaining power allocation for the second group of charging output ports, since all ports in the second group have reached their preset power and there is still remaining power left, the power allocation unit further allocates the remaining power to the third group of charging output ports. When allocating remaining power to the third group of charging output ports, define the current remaining power as P₂, P₂=P₁−remaining power allocated to the second group of charging output ports=120 W−90 W=30 W.

It is calculated that (current remaining power/number of ports not yet reaching preset power)=P₃/1=30 W, while the required supplementary power of Port 3-1 is 40 W. Since (current remaining power P₃/number of ports not yet reaching preset power) is less than the required supplementary power of Port 3-1, the power allocation unit allocates all of the current remaining power 30 W to Port 3-1. At this point, the remaining power allocation ends.

The portable energy storage device and the power allocation method of the present embodiment ensure that when multiple charging output ports are connected to power-receiving devices and the total required power exceeds the maximum power the device can provide, all ports can still operate at their preset minimum power. Furthermore, after multiple charging output ports are connected to power-receiving devices and power is allocated according to preset rules, if a power-receiving device is removed from a charging output port during operation, thereby changing the number of connected ports, power is reallocated according to the preset rules based on the current number of connected ports. In this way, the power released from the removed device can be redistributed to the remaining connected ports, enabling the portable energy storage device to output power as close as possible to its maximum capacity and achieve dynamic adjustment. Meanwhile, according to the portable energy storage device and power allocation method provided by the present invention, some of the charging output ports can have different preset priorities. As a result, users can set the priority order of multiple power-receiving devices according to actual needs, making the device convenient and easy to operate. In addition, some of the charging output ports can have same preset priorities. On the basis of the predefined power allocation logic, when distributing power to charging output ports of equal priority, the power configuration unit takes into account the required power of these ports and allocates the available power as evenly as possible.

It should be particularly noted that, as described above, in this embodiment, the so-called minimum output power and maximum output power refer to the minimum and maximum power that the power configuration unit can allocate to the corresponding port. Specifically, when a charging output port is connected to a power-receiving device and the requested load power of the device is 15 W, while the minimum output power of that port is 20 W, the power configuration unit will allocate at least the minimum output power to the port, i.e., at least 20 W. However, since the load only requires 15 W, the actual operating power of the charging output port will be 15 W, and the excess 5 W will not be redistributed to other ports. This design thereby achieves the aforementioned goal of ensuring that “all ports can operate at their preset minimum power,” and differs from prior art approaches in which the minimum allocation power is defined as the minimum allowable operating power of the power-receiving device. As a result, the device can operate in a more stable manner, with more rational and reliable power allocation.

### Embodiment 2

This embodiment provides a portable energy storage device capable of discharging from multiple ports simultaneously. Its structure is generally the same as the portable energy storage device provided in Embodiment 1. The main difference lies in: Embodiment 1 discussed the case where Y≥3 and among these Y charging output ports, there are at least two priorities and one of the priority includes at least two ports. This embodiment will further discuss other situations. For parts of this embodiment that are the same as Embodiment 1, they will not be redundantly described. The following directly explains the points of difference.

Similarly, in this embodiment, the number of charging output ports connected to power-receiving devices is defined as Y.
1. When Y=1, only one charging output port is connected to a power-receiving device, the power configuration unit allocates to that port the smaller of its maximum output power and the load request power.

Specifically, if the load request power of the charging output port is greater than the port's maximum output power, the port reports the maximum power it can support (i.e., the maximum output power), and the power configuration unit sets the port's allocated power to its maximum output power. If the load request power of the port is less than its maximum output power, the power configuration unit sets the port's allocated power to its load request power. If the load request power of the port is equal to its maximum output power, the power configuration unit sets the port's allocated power to the load request power (which equals the port's maximum output power.
2. When Y≥2 and the Y charging output ports have the same priority:
(1) if Pmax_out=(Pmin_c1+ . . . +Pmin_cY), that is, the maximum total output power of the portable energy storage device equals the sum of the minimum output powers of the charging output ports connected to power-receiving devices, the power configuration unit allocates to each connected charging output port its corresponding minimum output power;
(2) if Pmax_out≥(first preset power+ . . . +Y-th preset power), that is, the maximum total output power of the portable energy storage device is greater than or equal to the sum of the preset powers of the charging output ports connected to power-receiving devices, the power configuration unit allocates to each connected charging output port its corresponding preset power;
(3) if (Pmin_c1+ . . . +Pmin_cY)<Pmax_out<(first preset power+ . . . +Y-th preset power), the power configuration unit first satisfies the minimum output power of these charging output ports (i.e., it first allocates to each charging output port connected to a power-receiving device its corresponding minimum output power), and then sequentially allocates the remaining power according to priority until the remaining power becomes zero and follow the rules below:
\textcircled{1} if (current remaining power/number of charging output ports not yet reaching preset power)≤the required supplementary power of each charging output port not yet reaching preset power, the power configuration unit evenly distributes the remaining power among all charging output ports not yet reaching preset power;
\textcircled{2} if (current remaining power/number of charging output ports not yet reaching preset power)≤the required supplementary power of some charging output ports not yet reaching preset power, and (current remaining power/number of charging output ports not yet reaching preset power)>the required supplementary power of the other charging output ports not yet reaching preset power, the power configuration unit allocates the remaining power to the charging output ports not yet reaching preset power within the group by taking the minimum required supplementary power among such ports as the distribution power.
3. When Y≥2 and the Y charging output ports have different priorities:
(1) if Pmax_out=(Pmin_c1+ . . . +Pmin_cY), that is, the maximum total output power of the portable energy storage device equals the sum of the minimum output powers of the charging output ports connected to power-receiving devices, the power configuration unit allocates to each connected charging output port its corresponding minimum output power;
(2) if Pmax_out≥(first preset power+ . . . +Y-th preset power), that is, the maximum total output power of the portable energy storage device is greater than or equal to the sum of the preset powers of the charging output ports connected to power-receiving devices, the power configuration unit allocates to each connected charging output port its corresponding preset power;
(3) if (Pmin_c1+ . . . +Pmin_cY)<Pmax_out<(first preset power+ . . . +Y-th preset power), the power configuration unit first satisfies the minimum output power of these charging output ports (i.e., it first allocates to each charging output port connected to a power-receiving device its corresponding minimum output power), and then sequentially allocates the remaining power according to priority until the remaining power becomes zero and follow the rules below:
(1) the charging output ports are ranked from high to low priority, and the power allocation unit will only continue to allocate remaining power to the next charging output port when the previous charging output port has reached its preset power and there is still remaining power;
(2) for each charging output port, the difference between its current power and its preset power is defined as the required supplementary power of that port, then:
\textcircled{1} if the current remaining power≥the required supplementary power of that port, the power configuration unit allocates the remaining power making the port reaches its preset power;
\textcircled{2} if the current remaining power<the required supplementary power of that port, the power configuration unit allocates all remaining power to that port.

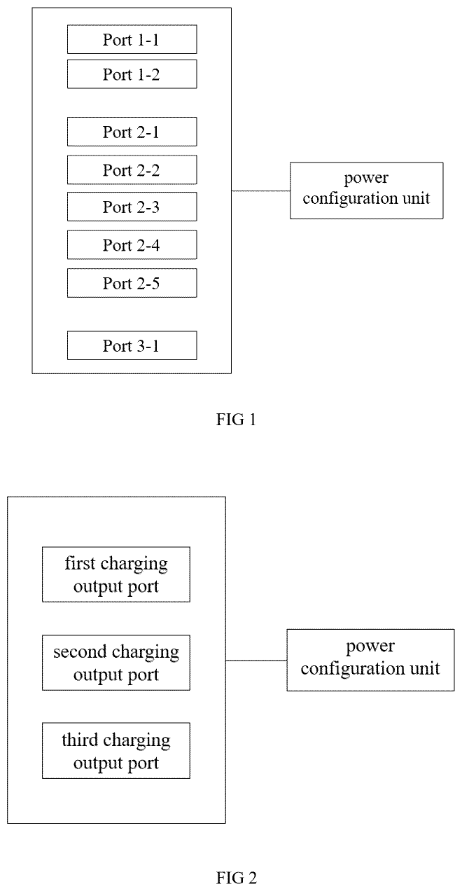

For example, when Y=3, that is, three charging output ports with different priorities are connected to power-receiving devices, as shown in FIG. 2, the charging output ports are sorted from high to low priority and sequentially defined as the first charging output port, second charging output port, and third charging output port. Their minimum output powers are sequentially defined as Pmin_c1, Pmin_c2, and Pmin_c3, and the smaller values between their maximum output powers and load request powers are respectively defined as the first preset power, second preset power, and third preset power.

In the portable energy storage device of the present invention, the charging output ports have at least two priorities and one of the priority includes at least two ports. When the number of charging output ports connected to power-receiving devices is 3, the total number of charging output ports in the portable energy storage device is at least 4. Therefore, the situation where Pmax_out=(Pmin_c1+Pmin_c2+Pmin_c3) does not exist. In this case:
(1) if Pmax_out≥(first preset power+second preset power+third preset power), the power allocation unit allocates the first preset power to the first charging output port, the second preset power to the second charging output port, and the third preset power to the third charging output port;
(2) if (Pmin_c1+Pmin_c2+Pmin_c3)<Pmax_out<(first preset power+second preset power+third preset power), the power allocation unit first satisfies the minimum output power of these charging output ports (i.e., the power allocation unit first allocates the corresponding minimum output power to these charging output ports), and then distributes the remaining power sequentially according to priority until the remaining power is 0. Define the initial amount of remaining power as P₀, P₀=Pmax_out−(Pmin_c1+Pmin_c2+Pmin_c3). The distribution rules are:

For remaining power allocation of the first charging output port, if the current remaining power P₀≥the supplemental power required by the first charging output port, the power allocation unit distributes the remaining power such that the first charging output port reaches its preset power; if the current remaining power P₀<the supplemental power required by the first charging output port, the power allocation unit allocates all of the current remaining power P₀ to the first charging output port.

After distributing the remaining power to the first charging output port, if there is still remaining power left, the power allocation unit continues to allocate the remaining power to the second charging output port, wherein the remaining power at this point is defined as P₁=P₀−the remaining power allocated to the first charging output port.

For remaining power allocation of the second charging output port, if the current remaining power P₁≥the supplemental power required by the second charging output port, the power allocation unit distributes the remaining power such that the second charging output port reaches its preset power; if the current remaining power P₁<the supplemental power required by the second charging output port, the power allocation unit allocates all of the current remaining power P₁ to the second charging output port.

After distributing the remaining power to the second charging output port, if there is still remaining power left, the power allocation unit continues to allocate the remaining power to the third charging output port, wherein the remaining power at this point is defined as P₂=P₁−the remaining power allocated to the second charging output port.

For remaining power allocation of the third charging output port, since the current remaining power P₂ is necessarily less than the supplemental power required by the third charging output port, the power allocation unit allocates all of the current remaining power P₂ to the third charging output port.

For the case where the Y charging output ports have different priorities, based on the above example, when Y takes other values, those skilled in the art can derive the corresponding power allocation scheme according to the above description.

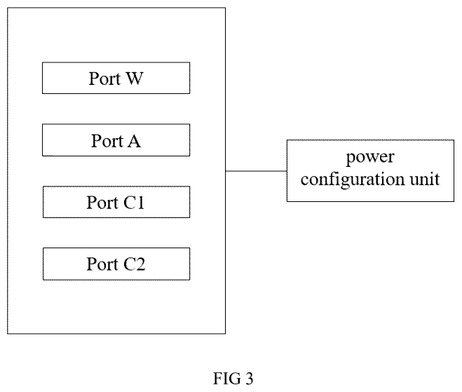

The following specific numerical values are substituted to provide a detailed description of the technical solution of the present embodiment: Assume that the portable energy storage device is equipped with four charging output ports, as shown in FIG. 3, namely Port W, Port A, Port C1, and Port C2. The priorities of these four charging output ports are set in the following order: W>A>C1=C2. When these four charging output ports are connected to power-receiving devices, the corresponding power data are listed in Table 2:

TABLE 2

| Relevant Parameters | Port W | Port A | Port C1 | Port C2 |
|---|---|---|---|---|
| Minimum output power | 20 W | 30 W | 50 w | 50 w |
| (Pmin) | | | | |
| Maximum output power | 40 W | 50 W | 70 w | 70 w |
| (Pmax) | | | | |
| Requested load power | 30 W | 60 W | 80 w | 80 w |
| Preset Power | 30 W | 50 W | 70 w | 70 w |

\textcircled{1} If only Port W is connected to a power-receiving device, since the smaller value between its maximum output power and the load request power is 30 W, the power configuration unit allocates 30 W to Port W. Similarly, if only Port C1 is connected to a power-receiving device, since the smaller value between its maximum output power and the load request power is 70 W, the power configuration unit allocates 70 W to Port C1.
\textcircled{2} When only Port C1 and Port C2 are connected to power-receiving devices:
assuming that Pmax_out=110 W, as Pmax_out<(the sum of the preset powers of Port C1 and Port C2), the power allocation unit first satisfies the minimum output power of Port C1 and Port C2. The current remaining power is Pmax_out−(Pmin_C1+Pmin_C2)=10 W. Since (current remaining power/number of charging output ports not yet reaching preset power)=10 W/2=5 W, while the required supplementary power of both Port C1 and Port C2 is 20 W, it can be seen that (current remaining power/number of charging output ports not yet reaching preset power)<the required supplementary power of each port. Therefore, the power allocation unit evenly distributes the remaining power 10 W to Port C1 and Port C2. Thus, the final total power obtained by Port C1 and Port C2 is 55 W each.
\textcircled{3} When only Port W, Port A, and Port C1 are connected to power-receiving devices: assuming Pmax_out=140 W, and since (Pmin_W+Pmin_A+Pmin_C1)<Pmax_out<(the sum of the preset powers of Ports W, A, and Cl), the power configuration unit first allocates the minimum output powers to Ports W, A, and C1, and then sequentially distributes the remaining power according to the priority order. The initial remaining power is defined as P₀, P₀=Pmax_out−(Pmin_W+Pmin_A+Pmin_C1)=140 W−100 W=40 W. The allocation of remaining power proceeds as follows:

Since Port W, Port A, and Port C1 have different priorities, the power allocation unit first allocates the remaining power to Port W. The supplementary power required by Port W is (preset power−current power)=10 W. As the remaining power P₀ is greater than the required supplementary power of Port W, the power allocation unit allocates sufficient remaining power to bring Port W to its preset power of 30 W. This means that Port W receives 10 W of the remaining power. The current remaining power is then defined as P₁, where P₁=P₀−the remaining power allocated to Port W=30 W. Since Port W has now reached its preset power and the current remaining power>0, the power allocation unit continues to allocate the remaining power to Port A.

The supplementary power required by Port A is (preset power−current power)=20 W. Since the remaining power P₁ is greater than the required supplementary power of Port A, the power allocation unit allocates remaining power to bring Port A to its preset power of 50 W. This means that Port A receives 20 W of the remaining power. The current remaining power is then defined as P₂, where P₂=P₁−the remaining power allocated to Port A=10 W. Since Port A has now reached its preset power and the current remaining power>0, the power allocation unit continues to allocate the remaining power to Port C1.

The supplementary power required by Port C1 is (preset power−current power)=20 W. Since the current remaining power P₂ is less than the required supplementary power of Port C1, the power allocation unit allocates all of the remaining power to Port C1, ending the remaining power distribution. After this power allocation, Port W reaches its preset power of 30 W, Port A reaches its preset power of 50 W, and Port C1 does not reach its preset power, with a total allocated power of 60 W.
\textcircled{4} If only Port W, Port C1, And Port C2 are connected to power-receiving devices:
assuming Pmax_out=140 W, since (Pmin_W+Pmin_C1+Pmin_C2)<Pmax_out<(the sum of the preset powers of Ports W, C1, and C2), the power allocation unit first satisfies the minimum output powers of Port W, Port C1, and Port C2, and then sequentially distributes the remaining power according to priority until the remaining power equals zero. The initial remaining power P₀=Pmax_out−(Pmin_W+Pmin_C1+Pmin_C2)=20 W. Since Port C1 and Port C2 have the same priority, Port W is defined as the first group of charging output ports, and Port C1 and Port C2 are defined as the second group of charging output ports. The rules for remaining power distribution are as follows:

Since the current remaining power P₀>the required supplementary power of Port W, the power allocation unit distributes the remaining power making Port W reaches its preset power. After distribution, the current remaining power is P₁=P₀−the remaining power allocated to Port W=20 W−10 W=10 W. Since P₁>0 and Port W has already reached its preset power, the remaining power can continue to be distributed to the second group of charging output ports, i.e., Port C1 and Port C2. For the second group, (current remaining power/number of charging output ports not yet reaching preset power)=10 W/2=5 W, which is less than the current required supplementary power of both Port C1 and Port C2. Therefore, the power allocation unit evenly distributes the remaining power P₁ to Port C1 and Port C2. After this distribution, Port W receives a total power of 30 W, and Port C1 and Port C2 each receive a total power of 55 W.
\textcircled{5} If Ports W, A, C1, and C2 are all connected to power-receiving devices:
Since (Pmin_W+Pmin_A+Pmin_C1+Pmin_C2)<Pmax_out<(the sum of the preset powers of Ports W, A, Cl, and C2), the power allocation unit first satisfies the minimum output power of Port W, Port A, Port C1, and Port C2. At this point, the remaining power P₀=Pmax_out−(Pmin_W+Pmin_A+Pmin_C1+Pmin_C2)=200 W−150 W=50 W. The distribution rule for this remaining 50 W is as follows:

Since Port C1 and Port C2 have the same priority, Port W is defined as the first group of charging output ports, Port A as the second group, and Port C1 and Port C2 as the third group. The power allocation unit first distributes the remaining power to the first group, i.e., Port W. Since the current remaining power P₀>the required supplementary power of Port W, the power allocation unit allocates power to make Port W reach its preset power of 30 W. This means Port W receives 10 W of the remaining power. The current remaining power is then defined as P₁=P₀−the power allocated to Port W=50 W−10 W=40 W. Because the first group has reached its preset power and the current remaining power>0, the power allocation unit continues to allocate the remaining power to the second group, i.e., Port A. Since the remaining power>the required supplementary power of Port A, the unit allocates power to bring Port A to its preset power of 50 W, meaning Port A receives 20 W of the remaining power. The current remaining power is then defined as P₂=P₁−the power allocated to Port A=40 W−20 W=20 W. Because the second group has reached its preset power and the current remaining power>0, the power allocation unit continues to distribute the remaining power to the third group, i.e., Port C1 and Port C2. For the third group, (current remaining power/number of charging output ports in the third group)=10 W, which is less than the required supplementary power of Port C1 and Port C2. Therefore, the power allocation unit evenly distributes the remaining power between Port C1 and Port C2. After the allocation, with a maximum output power of 200 W, the portable energy storage device provides Port W with 30 W, Port A with 50 W, and Port C1 and Port C2 each with 60 W.

Specifically, among Port W, Port A, Port C1, and Port C2, Port W and Port A can be unidirectional ports that only support discharging, while Port C1 and Port C2 can be bidirectional ports capable of both charging and discharging.

### Embodiment 3

This embodiment provides a power allocation method for a portable energy storage device, applicable to the portable energy storage devices described in embodiment 1 and embodiment 2. The structure of the portable energy storage device is as described in embodiment 1 and embodiment 2, and includes at least three charging output ports and a power configuration unit. The power configuration unit is configured to allocate power to the charging output ports connected to the power-receiving devices.

The charging output port are preset with a power distribution priority, and some of the charging output ports have the same priority. Each charging output port is preset with a minimum output power and a maximum output power. The maximum total output power of the portable energy storage device is defined as Pmax_out. Preset the sum of the minimum output powers of the charging output ports≤Pmax_out, the minimum output power of each charging output port≤its maximum output power, and the maximum output power of each charging output port≤Pmax_out.

The power allocation method includes:
when only one charging output port is connected to a power-receiving device, the power configuration unit allocates power to the single charging output port equal to the smaller of its maximum output power and the requested load power;
when the number of charging output ports connected to power-receiving devices≥2, the number of charging output ports connected to power-receiving devices is defined as Y These charging output ports are sorted in descending order of priority and sequentially defined as the first charging output port through the Y-th charging output port. Their minimum output powers are sequentially defined as Pmin_c1 through Pmin_cY, and their maximum output powers or the requested load powers, whichever is smaller, are sequentially defined as the first preset power through the Y-th preset power;
if Pmax_out=(Pmin_c1+ . . . +Pmin_cY), the power configuration unit allocates to each charging output port connected to a power-receiving device its corresponding minimum output power;
if Pmax_out≥(first preset power+ . . . +Y-th preset power), the power configuration unit allocates to each charging output port connected to a power-receiving device its corresponding preset power;
if (Pmin_c1+ . . . +Pmin_cY)<Pmax_out<(first preset power+ . . . +Y-th preset power), the power configuration unit first satisfies the minimum output power of said ports, allocating the remaining power in sequence according to the priority order until the remaining power becomes zero. This is divided into the following three cases.
1. When Y≥3 and the Y ports include at least two priorities and one of the priority includes at least two ports, the charging output ports with the same priority are defined as a charging output port group. In the process of distributing the remaining power, the power configuration unit follows the following rules:
first, the charging output port groups are ranked from high to low priority; when all ports in a higher-priority group have reached their preset power and there is still remaining power, the power configuration unit continues to allocate the remaining power to the next group of charging output ports;
second, for each port within a group, the difference between the current power of each port and its preset power is defined as the required supplementary power of that port, then:
(1) if the current remaining power≥the sum of required supplementary power of all ports not yet reaching their preset power, the power configuration unit allocates the remaining power making all such ports reach their preset power;
(2) if the current remaining power<the sum of required supplementary power of all ports not yet reaching their preset power, the power configuration unit continuously allocates the remaining power within the group according to the following rules until the remaining power becomes zero:
\textcircled{1} if (current remaining power/number of ports not yet reaching preset power)≤the required supplementary power of each port not yet reaching preset power, the remaining power is evenly distributed among all ports not yet reaching preset power by the power configuration unit;
\textcircled{2} if (current remaining power/number of ports not yet reaching preset power)≤the required supplementary power of some ports not yet reaching preset power, the power configuration unit allocates the remaining power to the ports not yet reaching preset power within the group by taking the minimum required supplementary power among such ports as the distribution power.
2. When Y≥2 and the Y charging output ports have different priorities, the power configuration unit first ensures the minimum output power of said ports, and then allocates the remaining power sequentially according to the priority order until the remaining power becomes zero, following the rules below:
(1) the charging output ports are ranked from high to low priority; when a higher-priority port reaches its preset power and there is still remaining power, the power configuration unit continues to allocate the remaining power to the next charging output port;
(2) for each charging output port, the difference between its current power and its preset power is defined as the required supplementary power of that port, then:
\textcircled{1} if the current remaining power≥the required supplementary power of that port, the power configuration unit allocates the remaining power making the port reaches its preset power;
\textcircled{2} if the current remaining power<the required supplementary power of that port, the power configuration unit allocates all remaining power to that port.
3. When Y≥2 and the Y charging output ports have the same priority, the power configuration unit first ensures the minimum output power of said ports, and then continuously allocates the remaining power until it becomes zero, following the rules below, in which the difference between the current power of each port and its preset power is defined as its required supplementary power:
(1) if (current remaining power/number of charging output ports not yet reaching preset power)≤the required supplementary power of each charging output port not yet reaching preset power, the power configuration unit evenly distributes the remaining power among all charging output ports not yet reaching preset power;
(2) if (current remaining power/number of charging output ports not yet reaching preset power)≤the required supplementary power of some charging output ports not yet reaching preset power, and (current remaining power/number of charging output ports not yet reaching preset power)>the required supplementary power of the other charging output ports not yet reaching preset power, the power configuration unit allocates the remaining power to the charging output ports not yet reaching preset power within the group by taking the minimum required supplementary power among such ports as the distribution power.

The specific embodiments of the present invention have been described above. Through the above description, relevant personnel can make various changes and modifications within the scope of the inventive idea of this invention.

1. A portable energy storage device capable of simultaneous multi-port discharge, wherein:
comprising a power configuration unit and at least three charging output ports, wherein the power configuration unit is configured to allocate power to the charging output ports connected to power-receiving devices, each charging output port being preset with a power distribution priority, a minimum output power, and a maximum output power; defining the maximum total output power of the energy storage device as Pmax_out, and the number of charging output ports connected to power-receiving devices as Y, defining these ports as the first to the Y-th charging output ports sequentially, their minimum output powers as Pmin_c1 to Pmin_cY, and the smaller of their maximum output power and load request power as the first to the Y-th preset powers;
when Y≥3 and the Y ports include at least two priorities and one of the priority includes at least two ports, define the ports of the same priority as a group; then when (Pmin_c1+ . . . +Pmin_cY)<Pmax_out<(first preset power+ . . . +Y-th preset power), the power configuration unit first satisfies the minimum output power of said ports, allocating the remaining power in sequence according to the priority order until the remaining power becomes zero and following the rules below:
first, the charging output port groups are ranked from high to low priority; when all ports in a higher-priority group have reached their preset power and there is still remaining power, the power configuration unit continues to allocate the remaining power to the next group of charging output ports; second, for each port within a group, the difference between the current power of each port and its preset power is defined as the required supplementary power of that port, then:
if the current remaining power≥the sum of required supplementary power of all ports not yet reaching their preset power, the power configuration unit allocates the remaining power making all such ports reach their preset power; if the current remaining power<the sum of required supplementary power of all ports not yet reaching their preset power, the power configuration unit continuously allocates the remaining power within the group according to the following rules until the remaining power becomes zero:
if (current remaining power/number of ports not yet reaching preset power)≤the required supplementary power of each port not yet reaching preset power, the remaining power is evenly distributed among all ports not yet reaching preset power by the power configuration unit;
if (current remaining power/number of ports not yet reaching preset power)≤the required supplementary power of some ports not yet reaching preset power, the power configuration unit allocates the remaining power to the ports not yet reaching preset power within the group by taking the minimum required supplementary power among such ports as the distribution power;
if Pmax_out=(Pmin_c1+ . . . +Pmin_cY), the power configuration unit allocates to each charging output port connected to a power-receiving device its corresponding minimum output power;
if Pmax_out≥(first preset power+ . . . +Y-th preset power), the power configuration unit allocates to each charging output port connected to a power-receiving device its corresponding preset power.

2. The portable energy storage device capable of simultaneous multi-port discharge according to claim 1, wherein,
the priority includes at least two ports is not lowest priority.

3. The portable energy storage device capable of simultaneous multi-port discharge according to claim 1, wherein,
in the case of (Pmin_c1+ . . . +Pmin_cY)<Pmax_out<(first preset power+ . . . +Y-th preset power), when Y≥2 and the Y charging output ports have different priorities, the power configuration unit first ensures the minimum output power of said ports, and then allocates the remaining power sequentially according to the priority order until the remaining power becomes zero, following the rules below:
first, the charging output ports are ranked from high to low priority; when a higher-priority port reaches its preset power and there is still remaining power, the power configuration unit continues to allocate the remaining power to the next charging output port;
second, for each charging output port, the difference between its current power and its preset power is defined as the required supplementary power of that port, then:
if the current remaining power≥the required supplementary power of that port, the power configuration unit allocates the remaining power making the port reaches its preset power;
if the current remaining power<the required supplementary power of that port, the power configuration unit allocates all remaining power to that port.

4. The portable energy storage device capable of simultaneous multi-port discharge according to claim 1, wherein,
in the case of (Pmin_c1+ . . . +Pmin_cY)<Pmax_out<(first preset power+ . . . +Y-th preset power), when Y≥2 and the Y charging output ports have the same priority, the power configuration unit first ensures the minimum output power of said ports, and then continuously allocates the remaining power until it becomes zero, following the rules below, in which the difference between the current power of each port and its preset power is defined as its required supplementary power:
if (current remaining power/number of charging output ports not yet reaching preset power)≤the required supplementary power of each charging output port not yet reaching preset power, the power configuration unit evenly distributes the remaining power among all charging output ports not yet reaching preset power;
if (current remaining power/number of charging output ports not yet reaching preset power)≤the required supplementary power of some charging output ports not yet reaching preset power, and (current remaining power/number of charging output ports not yet reaching preset power)>the required supplementary power of the other charging output ports not yet reaching preset power, the power configuration unit allocates the remaining power to the charging output ports not yet reaching preset power within the group by taking the minimum required supplementary power among such ports as the distribution power.

5. The portable energy storage device capable of simultaneous multi-port discharge according to claim 1, wherein,
when only one charging output port is connected to a power-receiving device, the power configuration unit allocates to the charging output port a power equal to the smaller of its maximum output power and the requested load power as the allocated power.

6. The portable energy storage device capable of simultaneous multi-port discharge according to claim 1 wherein,
the portable energy storage device comprises a main control board and one or more independent circuit boards connected to the main control board, the charging output ports provided on the circuit boards, and the power configuration unit being disposed on the main control board.

7. The portable energy storage device capable of simultaneous multi-port discharge according to claim 6, wherein,
the power configuration unit reads preset parameters of the charging output ports, calculates the real-time power demand of each charging output port, and allocates discharge power accordingly, the preset parameters including current and voltage.

8. The portable energy storage device capable of simultaneous multi-port discharge according to claim 6, wherein,
protection circuits are provided on both the circuit boards and the main control board, the protection circuits comprising one or more of: an over-current protection circuit, an over-voltage protection circuit, an over-temperature protection circuit, and a short-circuit protection circuit, and when an abnormal condition is detected, the protection circuit responds and interrupts the power supply of the relevant circuit.

9. A power allocation method for a portable energy storage device, wherein:
the method is applied to the portable energy storage device according to claim 1, comprising: when Y≥3 and the Y ports include at least two priorities and one of the priority includes at least two ports, define the ports of the same priority as a group; then when (Pmin_c1+ . . . +Pmin_cY)<Pmax_out<(first preset power+ . . . +Y-th preset power), the power configuration unit first satisfies the minimum output power of said ports, allocating the remaining power in sequence according to the priority order until the remaining power becomes zero and following the rules below:
first, the charging output port groups are ranked from high to low priority; when all ports in a higher-priority group have reached their preset power and there is still remaining power, the power configuration unit continues to allocate the remaining power to the next group of charging output ports; second, for each port within a group, the difference between the current power of each port and its preset power is defined as the required supplementary power of that port, then:
if the current remaining power≥the sum of required supplementary power of all ports not yet reaching their preset power, the power configuration unit allocates the remaining power making all such ports reach their preset power; if the current remaining power<the sum of required supplementary power of all ports not yet reaching their preset power, the power configuration unit continuously allocates the remaining power within the group according to the following rules until the remaining power becomes zero:
if (current remaining power/number of ports not yet reaching preset power)≤the required supplementary power of each port not yet reaching preset power, the remaining power is evenly distributed among all ports not yet reaching preset power by the power configuration unit;
if (current remaining power/number of ports not yet reaching preset power)≤the required supplementary power of some ports not yet reaching preset power, the power configuration unit allocates the remaining power to the ports not yet reaching preset power within the group by taking the minimum required supplementary power among such ports as the distribution power.

10. The power allocation method for a portable energy storage device according to claim 9, wherein,
in the case of (Pmin_c1+ . . . +Pmin_cY)<Pmax_out<(first preset power+ . . . +Y-th preset power), when Y≥2 and the Y charging output ports have different priorities, the power configuration unit first ensures the minimum output power of said ports, and then allocates the remaining power sequentially according to the priority order until the remaining power becomes zero, following the rules below:
first, the charging output ports are ranked from high to low priority; when a higher-priority port reaches its preset power and there is still remaining power, the power configuration unit continues to allocate the remaining power to the next charging output port;
second, for each charging output port, the difference between its current power and its preset power is defined as the required supplementary power of that port, then:
if the current remaining power≥the required supplementary power of that port, the power configuration unit allocates the remaining power making the port reaches its preset power;
if the current remaining power<the required supplementary power of that port, the power configuration unit allocates all remaining power to that port.

11. The power allocation method for a portable energy storage device according to claim 9, wherein,
in the case of (Pmin_c1+ . . . +Pmin_cY)<Pmax_out<(first preset power+ . . . +Y-th preset power), when Y≥2 and the Y charging output ports have the same priority, the power configuration unit first ensures the minimum output power of said ports, and then continuously allocates the remaining power until it becomes zero, following the rules below, in which the difference between the current power of each port and its preset power is defined as its required supplementary power:
if (current remaining power/number of charging output ports not yet reaching preset power)≤the required supplementary power of each charging output port not yet reaching preset power, the power configuration unit evenly distributes the remaining power among all charging output ports not yet reaching preset power;
if (current remaining power/number of charging output ports not yet reaching preset power)≤the required supplementary power of some charging output ports not yet reaching preset power, and (current remaining power/number of charging output ports not yet reaching preset power)>the required supplementary power of the other charging output ports not yet reaching preset power, the power configuration unit allocates the remaining power to the charging output ports not yet reaching preset power within the group by taking the minimum required supplementary power among such ports as the distribution power.

12. A power allocation method for a portable energy storage device, wherein:
the method is applied to the portable energy storage device according to claim 2, comprising: when Y≥3 and the Y ports include at least two priorities and one of the priority includes at least two ports, define the ports of the same priority as a group; then when (Pmin_c1+ . . . +Pmin_cY)<Pmax_out<(first preset power+ . . . +Y-th preset power), the power configuration unit first satisfies the minimum output power of said ports, allocating the remaining power in sequence according to the priority order until the remaining power becomes zero and following the rules below:
first, the charging output port groups are ranked from high to low priority; when all ports in a higher-priority group have reached their preset power and there is still remaining power, the power configuration unit continues to allocate the remaining power to the next group of charging output ports; second, for each port within a group, the difference between the current power of each port and its preset power is defined as the required supplementary power of that port, then:
if the current remaining power≥the sum of required supplementary power of all ports not yet reaching their preset power, the power configuration unit allocates the remaining power making all such ports reach their preset power; if the current remaining power<the sum of required supplementary power of all ports not yet reaching their preset power, the power configuration unit continuously allocates the remaining power within the group according to the following rules until the remaining power becomes zero:
if (current remaining power/number of ports not yet reaching preset power)≤the required supplementary power of each port not yet reaching preset power, the remaining power is evenly distributed among all ports not yet reaching preset power by the power configuration unit;
if (current remaining power/number of ports not yet reaching preset power)≤the required supplementary power of some ports not yet reaching preset power, the power configuration unit allocates the remaining power to the ports not yet reaching preset power within the group by taking the minimum required supplementary power among such ports as the distribution power.

13. A power allocation method for a portable energy storage device, wherein:
the method is applied to the portable energy storage device according to claim 3, comprising: when Y≥3 and the Y ports include at least two priorities and one of the priority includes at least two ports, define the ports of the same priority as a group; then when (Pmin_c1+ . . . +Pmin_cY)<Pmax_out<(first preset power+ . . . +Y-th preset power), the power configuration unit first satisfies the minimum output power of said ports, allocating the remaining power in sequence according to the priority order until the remaining power becomes zero and following the rules below:
first, the charging output port groups are ranked from high to low priority; when all ports in a higher-priority group have reached their preset power and there is still remaining power, the power configuration unit continues to allocate the remaining power to the next group of charging output ports; second, for each port within a group, the difference between the current power of each port and its preset power is defined as the required supplementary power of that port, then:
if the current remaining power≥the sum of required supplementary power of all ports not yet reaching their preset power, the power configuration unit allocates the remaining power making all such ports reach their preset power; if the current remaining power<the sum of required supplementary power of all ports not yet reaching their preset power, the power configuration unit continuously allocates the remaining power within the group according to the following rules until the remaining power becomes zero:
if (current remaining power/number of ports not yet reaching preset power)≤the required supplementary power of each port not yet reaching preset power, the remaining power is evenly distributed among all ports not yet reaching preset power by the power configuration unit;
if (current remaining power/number of ports not yet reaching preset power)≤the required supplementary power of some ports not yet reaching preset power, the power configuration unit allocates the remaining power to the ports not yet reaching preset power within the group by taking the minimum required supplementary power among such ports as the distribution power.

14. A power allocation method for a portable energy storage device, wherein:
the method is applied to the portable energy storage device according to claim 4, comprising: when Y≥3 and the Y ports include at least two priorities and one of the priority includes at least two ports, define the ports of the same priority as a group; then when (Pmin_c1+ . . . +Pmin_cY)<Pmax_out<(first preset power+ . . . +Y-th preset power), the power configuration unit first satisfies the minimum output power of said ports, allocating the remaining power in sequence according to the priority order until the remaining power becomes zero and following the rules below:
first, the charging output port groups are ranked from high to low priority; when all ports in a higher-priority group have reached their preset power and there is still remaining power, the power configuration unit continues to allocate the remaining power to the next group of charging output ports; second, for each port within a group, the difference between the current power of each port and its preset power is defined as the required supplementary power of that port, then:
if the current remaining power≥the sum of required supplementary power of all ports not yet reaching their preset power, the power configuration unit allocates the remaining power making all such ports reach their preset power; if the current remaining power<the sum of required supplementary power of all ports not yet reaching their preset power, the power configuration unit continuously allocates the remaining power within the group according to the following rules until the remaining power becomes zero:
if (current remaining power/number of ports not yet reaching preset power)≤the required supplementary power of each port not yet reaching preset power, the remaining power is evenly distributed among all ports not yet reaching preset power by the power configuration unit;
if (current remaining power/number of ports not yet reaching preset power)≤the required supplementary power of some ports not yet reaching preset power, the power configuration unit allocates the remaining power to the ports not yet reaching preset power within the group by taking the minimum required supplementary power among such ports as the distribution power.
